(19) United States
(12) Patent Application Publication
(10) Pub. No.: US 2005/0246379 A1
(43) Pub. Date: Nov. 3, 2005

(54) Communication system and method for modifying and transforming media files remotely

(75) Inventor: Wilson J. Chan, Foster City, CA (US)

Correspondence Address: JENNER & BLOCK, LLP, ONE IBM PLAZA, CHICAGO, IL, 60611, US

(73) Assignee: HarmonyCentral.com, Inc.

(21) Appl. No.: 11/175,652

(22) Filed: Jul. 5, 2005

Related U.S. Application Data
(63) Continuation of application No. 09/748,957, filed on Dec. 27, 2000.

(51) Int. Cl. G06F 7/00

(52) U.S. Cl. 707/104.1

(57) ABSTRACT

A communication system and method provides the ability to modify and transform media files remotely. The modification of a media file allows for media files, for example audio or video files, to be modified by adding effects such as echoes to preexisting audio or video files. The transformation of a media file allows for media files, for example MIDI files, to be transformed from music notation format into, for example, an audio file.

### CROSS-REFERENCE TO RELATED APPLICATION(S)

This application is a continuation of U.S. patent application Ser. No. 09/748,957, filed on Dec. 27, 2000 and entitled “Communication System and Method for Modifying and Transforming Media Files Remotely.”

### BACKGROUND OF THE INVENTION

1. Field of the Invention

The invention relates to a communication system and method for modifying and transforming media files remotely and, more particularly, to a system and method for modifying and transforming files, for example audio files, from a remote location using a network to link a remote user to a host computer that in turn controls audio equipment.

2. Description of the Related Art

Several methods and systems are known for modifying and storing media files, such as audio files and video files. These systems generally require the user to purchase hardware and software to modify and transform the media files. Such systems are expensive and require a lot of space.

For example, an individual may wish to modify an audio file. An audio file can consist of sounds that an individual has created using instruments or other tone generators and has saved in the form of a file that can be accessed at a later time. To modify such audio files, a user would have to buy expensive processing equipment adequate enough to modify the file as desired. For example, the user might buy an effects processor to allow the user to add special sound effects, such as echoes. Furthermore, the user needs to buy additional equipment to allow the user to input the audio file into the processing equipment. Such additional equipment might include, for example, a computer interface card that enables the computer to communicate with the processing equipment.

For example, an amateur musician may not quite grasp what layers upon layers of instruments would sound like when intertwined into a symphony composition the musician composed. Therefore, in order to hear the composition, the musician may hire an entire orchestra to play the music so that it then can be modified as desired and edited into final form. This, needless to say, is quite costly and impractical. Alternative means of achieving these goals also are not practical. One alternative would be to purchase all the instruments needed for the composition, learn the instruments, and record each individual instrument in order to layer them together to complete the composition. For most people, this is not a feasible option.

Another option would be to purchase processing equipment to emulate symphonic sounds. This can be done through known processing equipment that includes musical instrument digital interface (“MIDI”) capabilities. This type of processing equipment transforms media files in notation format into audio files containing actual tones of the notes. Such processing equipment can be extremely expensive. Some systems have been developed that work in conjunction with musical instruments and interact with the user as software installed on a computer. This may reduce the cost of modifying an audio file. However, one disadvantage to such a system is the relatively low quality of the modified file due to limitations of the software and hardware processing equipment that the user has to access locally. Another disadvantage to this type of system is the limit in the amount of storage space available to the user. For software systems, the storage space is limited to the space the user has available locally. This can be an important problem, especially in light of the typically large size of media files.

Therefore, it would be desirable to have a system that achieves high quality modifications and transformations of a media file, for example, an audio file, while drastically decreasing the amount of equipment a user has to purchase. Furthermore, it would be advantageous to have a system that enables the user to store the files in a space much larger than the user's hard drive or external storage devices.

### SUMMARY OF THE INVENTION

The present invention provides a communication system and method for modifying and transforming media files remotely. The communication system generally includes a memory for storing a media file, a personal communication device with access to the memory, at least one host computer, a network, means for modifying and/or transforming the media file and storage capacity for the media file.

Preferably, the present invention includes a personal computer as the personal communication device, a host computer running the LINUX operating system, and the Internet or a private network as the network.

The communication system can allow for transmission of information to the host computer from the personal communication device and preferably from the host computer to the personal communication device. The information transmitted can be in the form of a media file having one of a plurality of predetermined formats. The media file can be, for example, an audio file, a video file or a music notation file.

The media file can be modified and/or transformed by equipment such as a media patchbay and a media interface device. The media file can be modified numerous times in accordance with the user's requirements through the use of a media switch matrix and a media interface device control repeater.

The media switch matrix allows for the media file to be routed through to the modification and/or transformation equipment necessary to make the user-selected modifications and transformations and also allows for alternating between the modification and transformation equipment to achieve the best modification or transformation of the media file. For example, the media file could be modified to add echoes to the music, and then further modified to change the instruments playing the music by passing the media file through the media switch matrix a plurality of times.

The media interface device control repeater can receive a control signal from the host computer and can send multiple outputs to the equipment that performs the necessary modification or transformation of the media file. The media interface device control repeater aids in the correct identification and selection of the processor(s) that will modify or transform the media file as requested by the user.

Once the media file is modified or transformed as desired by the user, the media file is sent back to the host computer, which can notify the user that the media file is modified as requested. This notification can take place, for example, via email. The user then can access the modified media file in a variety of ways. For example, the modified media file can be obtained by accessing the host computer or, in the alternative, physically retrieving the file from the host system.

This communication system for modifying and transforming media files remotely is advantageous because it eliminates the expensive equipment needed by a user to modify a media file adequately and thereby provides a low cost solution to the problem of efficiently modifying and transforming media files.

The present invention also includes a method for modifying and transforming media files remotely. The method can include the steps of providing a media file in a memory accessible by a personal communication device such as a personal computer, transmitting the media file over a network to a host computer, modifying the media file with modifying equipment, transforming the media file with transformation equipment, and storing the modified or transformed media file in a second memory associated with the host computer.

Additional advantages and features of the present invention will become apparent from the reading of the attached description of the preferred embodiment and the following set of drawings.

### BRIEF DESCRIPTION OF THE DRAWINGS

FIG. 1 is a schematic diagram of a communication system incorporating the present invention;

FIG. 2 is a schematic diagram of a portion of the system of FIG. 1;

FIG. 3 is a schematic diagram of a portion of the system of FIG. 1; and

FIG. 4 is a schematic diagram of a media switch matrix for use in the present invention.

### DETAILED DESCRIPTION OF THE PREFERRED EMBODIMENT

The communication system and method of the present invention overcomes the disadvantages of prior systems by enabling a user to transmit media files so that they can be modified and/or transformed, and stored remotely. The media files can include, for example, audio files, video files, and music notation files. An audio file can be, for example, prerecorded music or sounds or live music or sounds in a variety of formats. A video file can be, for example, prerecorded motion picture images or live motion picture images in a variety of formats. A music notation file can be, for example, manually entered conventional music notes that describe the melody of a song or a musical instrument digital interface (“MIDI”) file.

The present invention can be offered in the environment of a graphical user interface that is similar to a conventional “web browser.” Within the present invention's graphical user interface, the user can select what modification or transformation will be done to a file that the user imports into the system. For example, the user may wish to add an echo to an audio file or may wish to have a MIDI file transformed into an audio file reflecting the sounds created by the playing of the musical notes set out in the file. Furthermore, the user could take a MIDI file or an audio file and modify the file to create an audio file reflecting the sounds of certain instruments of the user's choosing playing the music. Of course, the capability to perform numerous other types of modifications or transformations may be included in a given application, as desired.

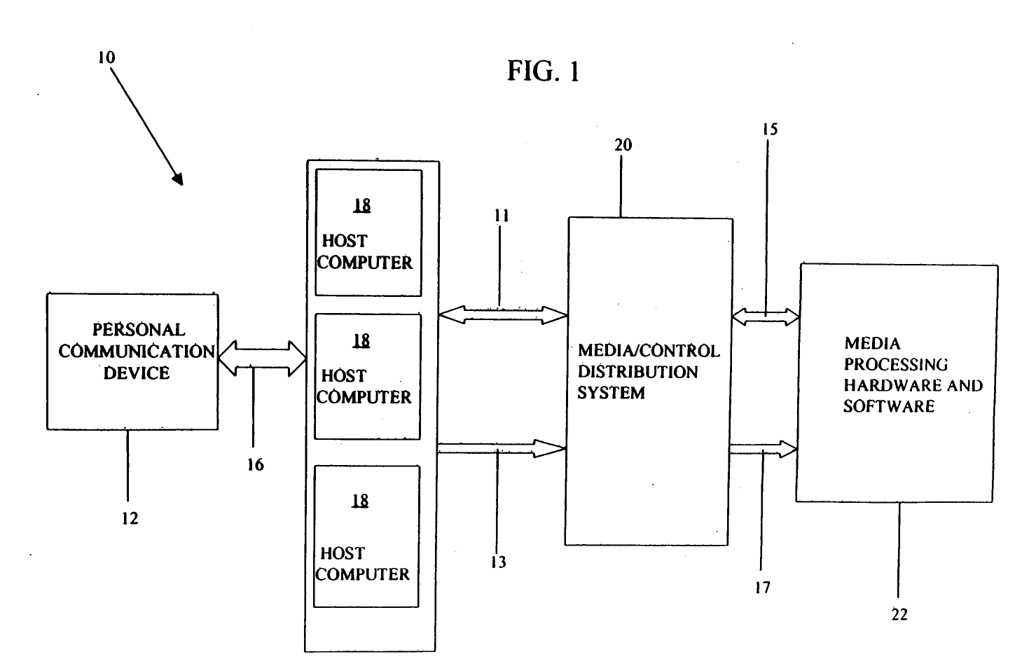

FIG. 1 depicts schematically a system 10 in accordance with the present invention. System 10 can include a personal communication device 12, a network 16, at least one host computer 18, a media/control distribution system 20, and media processing hardware and software generally designated by reference numeral 22. System 10 preferably includes more than one host computer 18, but in the simplest embodiment, one host computer will suffice. The elements of system 10 have the ability to communicate with each other by means of wire or other connecting means represented by arrows 11, 13, 15, 16 and 17. Alternatively, system 10 can provide communication between various elements by means of wireless communication.

An individual uses personal communication device 12 to input the requested modification or transformation of a media file. Personal communication device 12 communicates with host computer 18 over network 16. Personal communication device 12 can be, for example, a personal computer, a hand-held computer, or any other device capable of transmitting information over network 16. Network 16 can include a connection, in whole or in part, over the Internet or other public network. Alternatively, network 16 can be solely a private network. Network 16 can include cables or can be wireless.

Host computer 18 receives transmissions, such as media files to be modified or transformed, from personal communication device 12 over network 16. Preferably, host computer 18 also can transmit information such as modified media files back to personal communication device 12 over network 16. Host computer 18 also communicates with media/control distribution system 20. Host computer 18 and media/control distribution system 20 can transmit media files over connections 11 and 13.

Host computer 18 preferably includes an Intel®-based processor and runs LINUX as its operating system. A user chooses how a media file is to be modified and/or transformed and selects from a plurality of predetermined options on the graphical user interface. For example, the options might include adding echoes to an audio file or transforming a MIDI file into an audio file of one or more instruments (e.g., a piano) playing the music. Once host computer 18 receives the user's selected option, host computer 18 transmits the user's request to media/control distribution system 20.

Media/control distribution system 20 receives information from host computer 18 over connections 11 and 13 and communicates with media processing hardware and software 22 via connections 15 and 17. Media/control distribution system 20 sends media files over connection 15 and control signals over connection 17. Media processing hardware and software 22 performs the actual modification of the media file as requested by the user. After modification is complete, media processing hardware and software 22 transmits the modified media file to host computer 18 through media/control distribution system 20. Host computer 18 can communicate with personal communication device 12 by sending information over network 16 notifying the user that a media file is finished being modified and/or transformed.

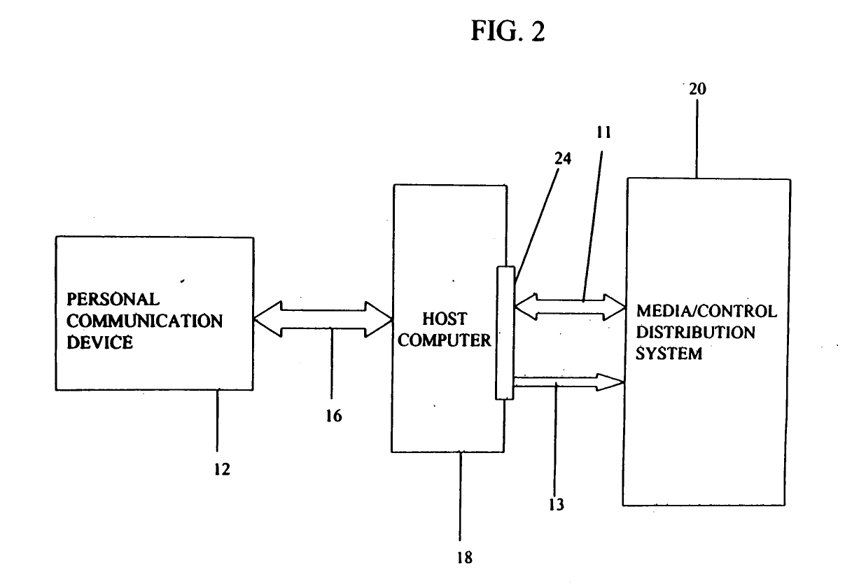

FIG. 2 is a schematic diagram of a portion of a system in accordance with the present invention. Host computer 18 receives a media file transmitted by personal communication device 12 via connection 16. At least one media interface card 24 is installed in a conventional manner to host computer 18. Media interface card 24 can include a MIDI card and/or an audio interface card, or one of a plurality of interface cards that are compatible with a media file in the present invention. Media interface card 24 allows host computer 18 to transmit media files to media/control distribution system 20 and can allow media/control distribution system 20 to transmit modified media files to host computer 18 after processing by media processing hardware and software 22.

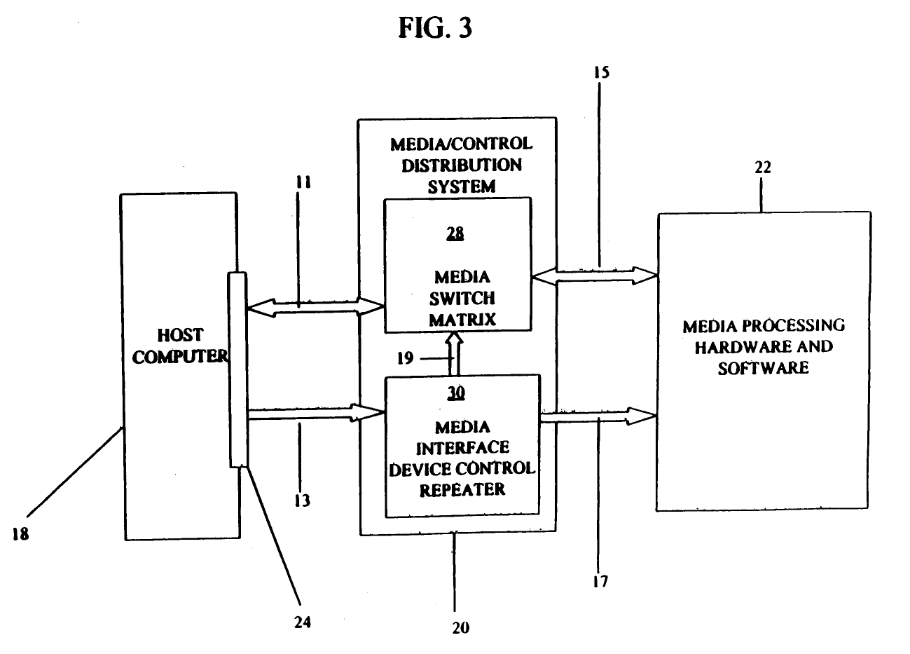

FIG. 3 is a schematic diagram of a portion of a system in accordance with the present invention showing that media/control distribution system 20 includes a media switch matrix 28 and a media interface device control repeater 30. Media interface device control repeater 30 can transmit information to media switch matrix 28 over a connection 19. Media switch matrix 28 and host computer 18 communicate via a connection 11 and through interface card 24. Media switch matrix 28 accepts input media files, such as audio files or video files, and preferably other than music notation files, and routes the media files to media processing hardware and software 22 via connection 15.

Media interface device control repeater 30 can accept music notation files from host computer 18 through interface card 24 and over connection 13. Media interface device control repeater 30 communicates with media processing hardware and software 22 via connection 17. System 10 preferably includes a digital audio patchbay (not shown), such as the Midiman Digipatch 12×6 patchbay available from Midiman in Arcadia, Calif., between media switch matrix 28 and media processing hardware and software 22 to convert the media file to a format that enables media processing hardware and software 22 to make the requested modification to the media file, as is known to those of ordinary skill in the art.

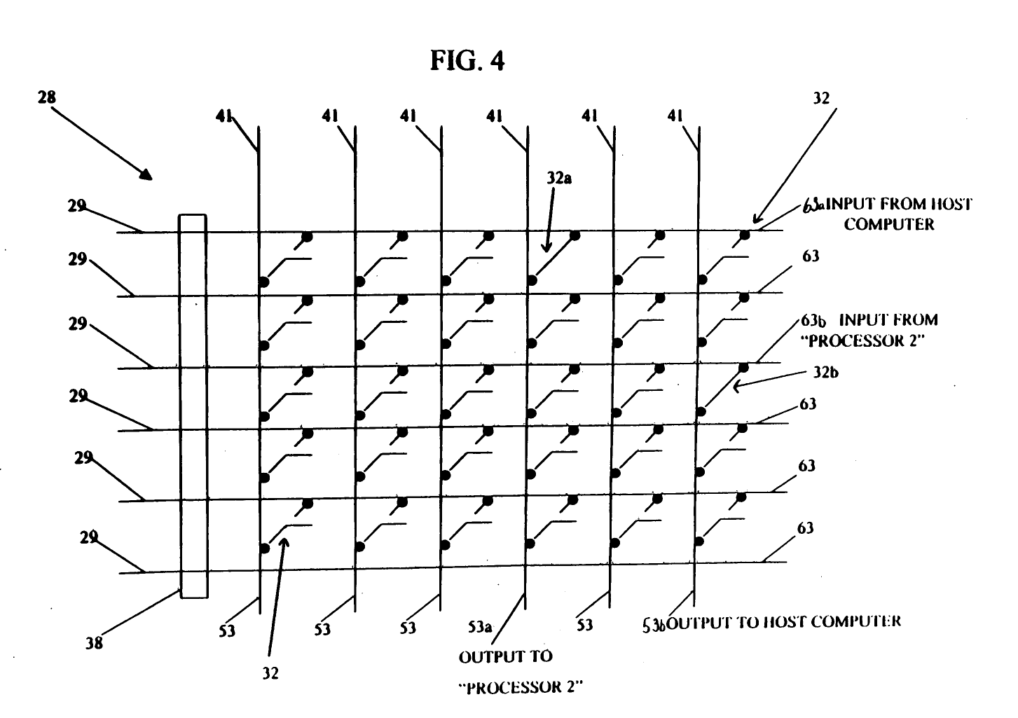

FIG. 4 is a detailed schematic diagram of media switch matrix 28 which can be used in conjunction with the present invention. Media switch matrix 28 enables the system user to perform multiple modifications to a media file that is inputted to system 10. The system can select more than one processor within media processing hardware and software 22 to modify a media file, when necessary. Ordinarily, this multiple modification would not be present in a remote system such as in the present invention. However, through a “chaining” process, media switch matrix 28 allows for multiple modifications of a media file.

Media switch matrix 28 can include a plurality of switches 32, a plurality of rows of wires 29, a plurality of columns of wires 41, inputs 63 from host computers 18 and processors in media processing hardware and software 22, outputs 53 to host computers 18 and processors in media processing hardware and software 22, and switch controls 38. The quantity of rows and the quantity of columns both can equal the number of processors in media processing hardware and software 22 plus the number of host computers 18 in the system. For example, if there are four host computers 18 and five processors in media processing hardware and software 22, then there can be nine rows and nine columns to complete the cross-point matrix. Because of this cross-point design, media switch matrix 28 allows media equipment such as processors to be connected in any order.

The unique function of chaining in media switch matrix 28 occurs when a media file is inputted to media switch matrix 28 by host computer 18 via one of inputs 63. Media switch matrix 28 then routes the media file via one of outputs 53 to the processor which has been assigned the task of performing the type of modification or transformation requested by the user. This is accomplished by closing one of switches 32 by activating the corresponding switch controls 38 by electronic or other known means. When selected switch 32 is closed, the media file is passed from one of inputs 63 to one of outputs 53 via media switch matrix 28. The particular input 63 and output 53 define the appropriate switch 32 to be closed.

If the user chooses to perform multiple modifications upon a media file, media switch matrix 28 will use a chaining process. When this occurs, the system retransmits the modified or transformed media file through media switch matrix 28 via that one of inputs 63 connected to the processor to which the media file previously was sent for modification or transformation. For example, as shown in FIG. 4, a media file first could come into media switch matrix 28 through input 63a from a particular host computer 18. If a user selected a modification or transformation that the system performs using “processor 2,” the system would route the media file to “processor 2.” As shown in FIG. 4, output 53a connects to “processor 2.” Thus, switch 32a is closed, thereby allowing the system to route the media file to “processor 2” via output 53a. Once “processor 2” finishes modifying the media file, the system will send the modified media file back into media switch matrix 28 through input 63b that comes from “processor 2.” The modified media file then can be sent to whichever processor is to perform the next modification step by closing the appropriate switch 32 to route the modified media file to that processor for further modification. This “chaining” process will continue until all of the modifications of the media file necessary to meet the user's request are complete.

When further modification is not necessary, the media file will exit media switch matrix 28 via that one of outputs 53 which is connected to the media file's final destination. For example, when the user's request does not require any further modification to the media file, the system closes a switch 32 to route the media file to the appropriate host computer 18. In the example of FIG. 4, the media file is done being modified after returning from “processor 2.” Therefore, the system closes switch 32b and routes the finished modified media file to the appropriate host computer 18 via output 53b.

Referring back to FIG. 3, media interface device control repeater 30 allows for the correct selection of the processor for the chosen modification of a media file. Media interface device control repeater 30 also allows for the processing of a media file that is in the form of a music notation file. Because a music notation file preferably does not pass through media switch matrix 28, it can be transformed by passing through media interface device control repeater 30 and on to media processing hardware and software 22. Media interface device control repeater 30 comprises at least one input from host computer 18 shown by arrow 13, an output 19 to media switch matrix 28, and at least one output shown by arrow 17 to the processors in media processing hardware and software 22. For media file transformation, a Midiman Thru 3×8 MIDI processor (not shown) available from Midiman in Arcadia, Calif. preferably is placed between media interface device control repeater 30 and media processing hardware and software 22.

When the user selects a modification to be made to a media file, the request is sent to media interface device control repeater 30. Media interface device control repeater 30 then sends the request to the appropriate processor via connection 17 instructing the processor as to what type of modification is to be performed. Because each processor is identified by a unique address, when media interface device control repeater 30 sends the request, only the selected processor sets itself to the requested setting.

Media processing hardware and software 22 includes a connection, generally designated by reference numeral 15, to media switch matrix 28, a connection 17 from media interface device control repeater 30 and at least one processor (not shown). The media file enters media processing hardware and software 22 via connection 15 and is modified by at least one processor in media processing hardware and software 22. At this point, the media file can be in audio, video, or music notation form. If the input is audio or video, the format of the input is in digital form. In digital form, media processing hardware and software 22 can add special effects and the like through the use of one or more processors. For example, if a user sends an audio file of music created using conventional instruments, media processing hardware and software 22 can add effects such as echoes to the music. The amount of effects that are available are limited only by the amount of effects in the processor.

In music notation form, there is not a digital audio file present. Therefore, in order for a digital file to be created and thus allow a user to hear what is contained within the music notation file, the music notation file needs to be transformed into digital audio form. In general, a music notation file (such as a MIDI file) only describes what notes are played and has no audio output. However, media processing hardware and software 22 generates the corresponding tones to the notes of the music notation file. The media processing hardware and software 22 then can save the tones to a digital audio file. When media processing hardware and software 22 outputs the media file, the media file then can return to media switch matrix 28 and then on to host computer 18 provided that all requested media file modification is completed.

Referring once again to FIG. 1, the now modified and/or transformed media file can be stored in the host computer 18 that originally received the user's request. In the alternative, modified media file may be stored or held in a different host computer 18 or in some other device. Preferably, host computer 18 notifies personal communication device 12 that the system has completed modifying or transforming the media file. This notification is accomplished by means of electronic mail in the preferred embodiment of the invention, however other means of notification may be used. Once notification is received by the user through personal communication device 12, the user can access media file remotely from host computer 18 or wherever the media file is stored. Alternatively, the user can access the media file by physically obtaining it at a storage location.

Thus, there has been described a system and method for modifying and transforming media files remotely without requiring a user to purchase large amounts of expensive equipment.

Whereas the present invention has been described with respect to specifics embodiments thereof, it will be understood that various changes and modifications will be suggested to one skilled in the art and it is intended that the invention encompass such changes and modifications as fall within the scope of the appended claims.

1. A system for remotely modifying and transforming media files, comprising:
a memory for storing a plurality of types of media files;
a host computer;
a personal communication device, said personal communication device having access to said memory and said personal communication device being adapted to transmit the plurality of types of media files to said host computer;
means accessible to said host computer for modifying the plurality of types of media files;
means for storing the modified plurality of types of media files;
a media switch matrix for routing the plurality of types of media files to said modifying means, wherein the media switch matrix uses a chaining process to route the plurality of types of media files to said modifying means; and
a media interface device control repeater for selecting one of a predetermined plurality of modifications to be performed by said modifying means.

2. The system of claim 1 wherein said host computer is adapted to transmit information to said personal communication device.

3. The system of claim 2 wherein said host computer is adapted to receive said plurality of types of media files from said personal communication device over the Internet.

4. The system of claim 2 wherein said host computer is adapted to receive said plurality of types of media files from said personal communication device over a private network.

5. The system of claim 1 wherein said host computer is adapted to receive a media file that is in any one of a plurality of predetermined formats.

6. The system of claim 1 wherein said modifying means includes a media patchbay and a media interface device.

7. The system of claim 1 wherein said media interface device control repeater comprises means for receiving a control signal from said host computer and means for sending multiple outputs to said modifying means.

8. The system of claim 1 wherein said media switch matrix comprises means for routing said plurality of types of media files through said media switch matrix a plurality of times.

9. The system of claim 1 wherein said host computer is adapted to receive a media file that is a video file.

10. The system of claim 1 wherein said host computer is adapted to receive a media file that is an audio file.

11. The system of claim 1 wherein said host computer is adapted to receive a media file that is a music notation file.

12. A system for remotely modifying and transforming media files, comprising:
a memory for storing a plurality of types of media files;
a personal communication device, said personal communication device having access to said memory;
a host computer;
a network to allow communication from said personal communication device to said host computer and from said host computer to said personal communication device;
means accessible to said host computer for transforming said plurality of types of media files;
a media switch matrix for routing said plurality of types of the media files to said transforming means, wherein the media switch matrix uses a chaining process to route the plurality of types of media files to said transforming means; and
a media interface device control repeater for selecting one of a predetermined plurality of transformations to be performed by said transforming means.

13. The system of claim 12 wherein said transforming means includes a media patchbay and a media interface device.

14. The system of claim 12 wherein said media interface device control repeater comprises means for receiving a control signal from said host computer and means for sending multiple outputs to said transforming means.
